(19) United States
(12) Patent Application Publication
(10) Pub. No.: US 2017/0228690 A1
(43) Pub. Date: Aug. 10, 2017

(54) SYSTEM AND METHOD FOR DELIVERY RECEIPTING AND USER AUTHENTICATION IN UNMANNED PRODUCT DELIVERIES

(71) Applicant: MasterCard International Incorporated, Purchase, NY (US)

(72) Inventor: Manoneet Kohli, O'Fallon, MO (US)

(21) Appl. No.: 15/040,426

(22) Filed: Feb. 10, 2016

(51) Int. Cl. G06Q 10/08; G06Q 20/10; G06Q 20/40

(52) U.S. Cl. CPC G06Q 10/0832; G06Q 20/40145; G06Q 20/10

(57) ABSTRACT

A method includes transporting an item for delivery to a delivery location by an unmanned vehicle. The method further includes receiving a signal that authenticates a recipient present at the delivery location. In addition, the method includes releasing the item from the unmanned vehicle to the recipient in response to the received signal.

### BACKGROUND

With widespread adoption of online shopping, there has been a great expansion of the number of items shipped to a customer's home or another delivery point in response to a direct order from the customer to the merchant. Thus online shopping has augmented the previously and still existing ordering channels of mail order and telephone ordering (“MOTO”).

In a typical online shopping or MOTO transaction, a carrier such as the U.S. Postal Service, Fedex or UPS sends an employee with the item ordered to the delivery location to effect delivery. There have, however, been proposals to effect delivery in an unmanned fashion, such as by drone or self-driving automobile.

Unmanned delivery presents potential challenges as to confirming that delivery was properly made to the intended recipient. Moreover, further challenges may be presented if the customer wishes to pay the transaction price or a portion thereof at the time of delivery.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional system that handles online purchase transactions.

FIG. 2 is a block diagram of a conventional payment account system.

FIG. 3 is a block diagram showing a system for unmanned delivery of items according to teachings of the present disclosure.

FIG. 4 is a block diagram showing an alternative embodiment of the system of FIG. 3.

FIG. 5 is a schematic illustration of an unmanned vehicle (UMV) that may be included in the system of FIG. 3 or FIG. 4 according to teachings of the present disclosure.

FIG. 6 is a block diagram representation of a payment transaction reader component of the UMV of FIG. 5.

FIG. 7 is a block diagram of a computer system that may perform functions according to teachings of the present disclosure in connection with the system of FIG. 3 or FIG. 4.

FIG. 8 is a block diagram of a mobile device that may be used by a customer/parcel recipient in connection with the system of FIG. 3 or FIG. 4.

FIGS. 9 and 10 are flow charts that illustrate processes that may be performed in connection with aspects of the present disclosure in the system of FIG. 3 or FIG. 4.

### DETAILED DESCRIPTION

In general, and for the purpose of introducing concepts of embodiments of the present disclosure, a biometric authentication may be performed at the point of delivery with respect to a parcel recipient. Upon successful completion of the authentication, a UMV that is making the delivery may release to the recipient the product item that is being delivered.

In addition or alternatively, a payment transaction to cover the full purchase price or an unpaid balance thereof may be initiated at the point of delivery before the UMS releases the product item to the recipient. The payment transaction may be initiated by a payment-enabled mobile device carried by the recipient and/or may rely on POS (point of sale) terminal functionality that is incorporated in the UMV according to some embodiments. In addition or alternatively, the UMV may incorporate one or more components for receiving biometric input from the recipient.

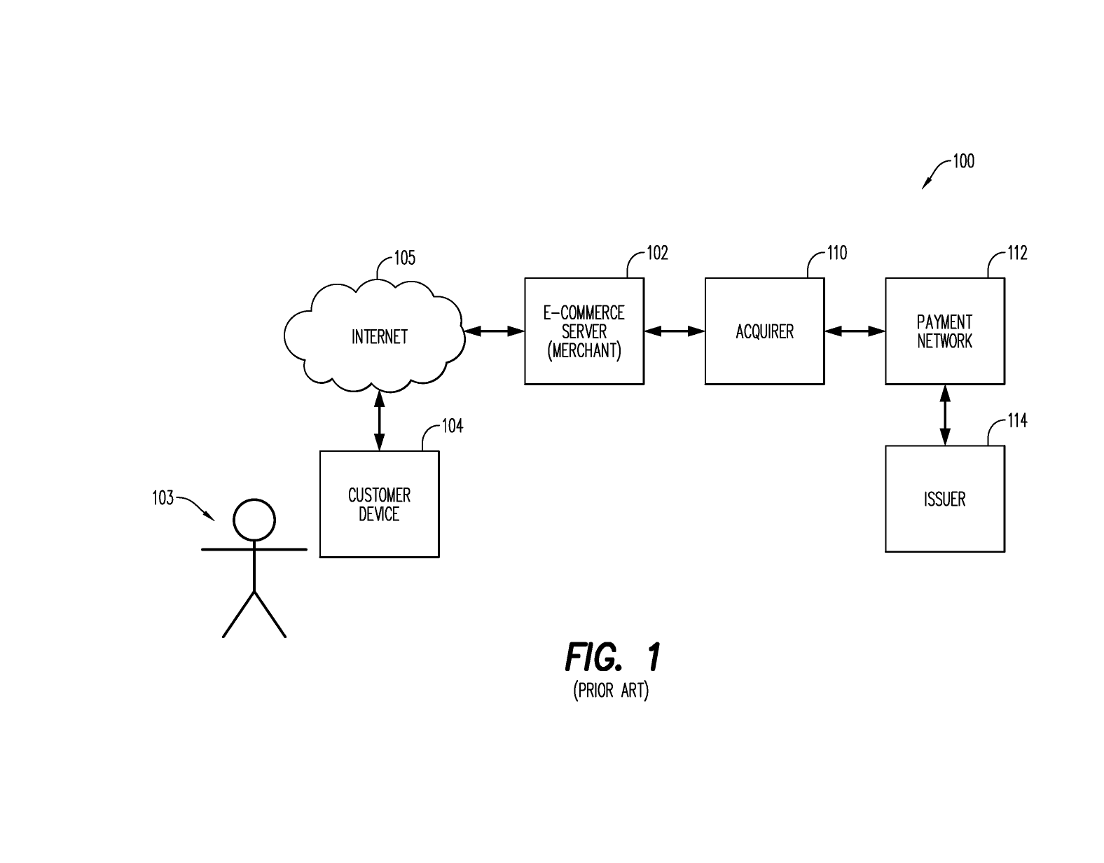

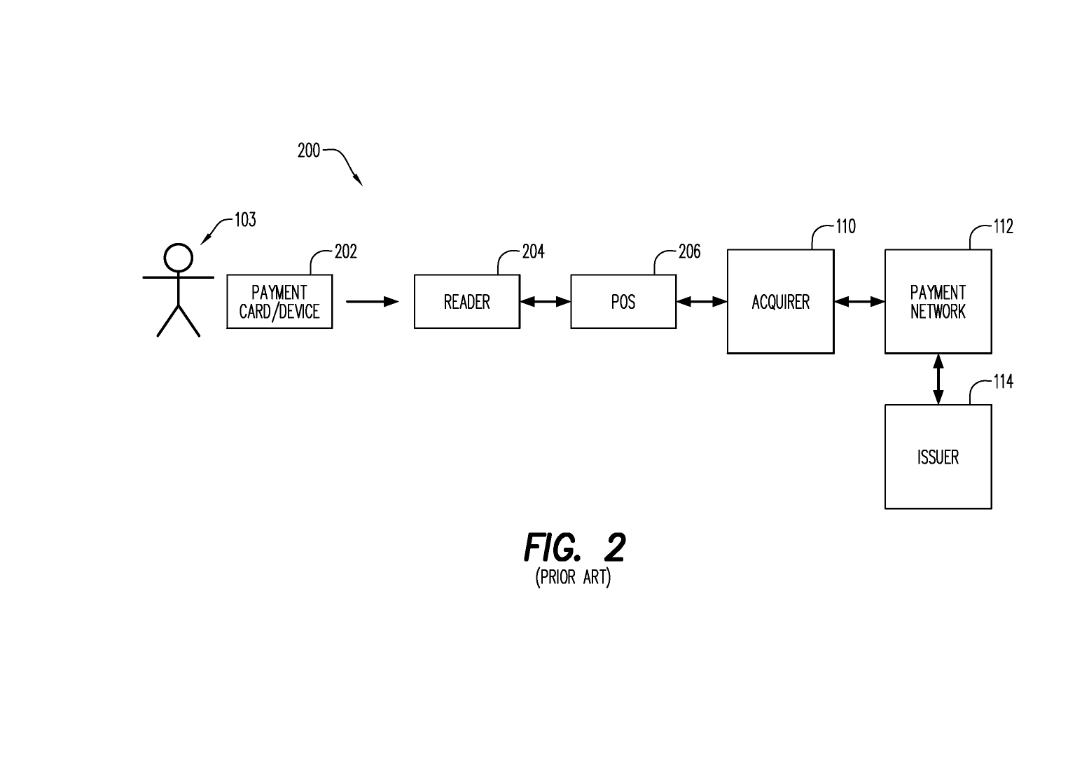

By way of background to the description of the teachings of the present disclosure, some aspects of conventional payment systems will now be described with reference to FIGS. 1 and 2.

FIG. 1 is a block diagram of a conventional payment system 100 as it may operate in connection with an online purchase transaction.

The system 100 includes an e-commerce server computer 102 that may be operated by or on behalf of an online merchant to permit online shopping transactions. For this purpose, as is well known, the e-commerce server computer 102 may host a shopping website, sometimes referred to as an “online store”. A customer 103 who operates a customer device 104 may access the shopping website by communicating over the Internet 105 with the e-commerce server computer 102. As is very well-known to those who are skilled in the art, the customer device 104 may be, for example, a personal computer or notebook computer that runs a browser program, a tablet computer or smartphone that runs a mobile browser and/or a suitable app, etc. As is very familiar to those who shop online, after the customer has selected one or more items of merchandise for purchase from the online store, he/she may elect to enter a checkout phase of the online purchase transaction. In some situations, during the checkout phase, the customer enters payment information, such as a payment account number, expiration date, security code, etc. into an online form.

In connection with the online purchase transaction, the e-commerce server computer 102 may transmit a transaction authorization request message (sometimes simply referred to as an “authorization request”) to the merchant's acquirer financial institution (“acquirer” or “transaction acquirer”), indicated by reference numeral 110. The authorization request may include the payment data provided by the customer 103 to the e-commerce server 102 via the customer device 104 through data transmission over the internet 105.

The acquirer 110 may route the authorization request via a payment network 112 to a server computer 114 operated by the issuer of the payment account that corresponds to the payment data included in the authorization request. Also, the authorization response generated by the issuer server computer 114 may be routed back to the acquirer 110 via the payment network 112. The acquirer 110 may confirm to the merchant (i.e., to the e-commerce server computer 102) that the transaction has been approved. Within a short time (usually a few days or less) the merchant may initiate shipment of the ordered item(s) to the customer 103.

The payment network 112 may be, for example, the well-known Banknet® system operated by MasterCard International Incorporated, which is the assignee hereof.

The components of the system 100 as depicted in FIG. 1 are only those that are needed for processing a single transaction. Those who are skilled in the art will recognize that in the real world, online shopping and payment systems may process many purchase transactions (including simultaneous transactions) and may include a considerable number of payment account issuers and their computers, a considerable number of acquirers and their computers, and numerous merchants and their e-commerce servers. The system may also include a very large number of customers/online shoppers, who hold payment accounts that they use for their online shopping activities. It is also well known that elements of the system 100 (e.g., acquirers, the payment network, payment account issuers) may play similar roles in connection with in-store purchase transactions and in other types of transactions.

Conventional aspects of payment systems in regard to in-store transactions will now be described, with reference to FIG. 2.

A payment system, generally indicated at 200, is shown in FIG. 2.

The system 200 includes a conventional payment card/device 202 (which may be, for example, a magnetic stripe card, a payment IC card, or a payment-enabled mobile device that stores a payment card account number or payment token and runs a payment app). The system 200 further includes a reader component 204 associated with a POS terminal 206. In some known manner (depending on the type of the payment card/device 202) the reader component 204 is capable of reading the payment card account number/token and other information from the payment card/device 202. In some situations, the payment device 202 is a mobile device that runs an application to allow access to a payment token subject to user authentication by verification of the user's fingerprint via a fingerprint sensor on the mobile device.

The reader component 204 and the POS terminal 206 may be located at the premises of a retail store and operated by a sales associate of the retailer for the purpose of processing retail transactions. The payment card/device 202 is shown in FIG. 2 to be interacting with the reader component 204 and the POS terminal 206 for the purpose of executing such a transaction. Reference numeral 103 indicates a customer (i.e., a user/account holder) who has visited the retail store and who has presented the payment card/device 202 to the reader component in order to settle the retail transaction.

As in the system 100 shown in FIG. 1, an acquirer computer 110 is also shown as part of the system of FIG. 2. The acquirer computer 110 may operate in a conventional manner to receive an authorization request for the transaction from the POS terminal 206. As before, the acquirer computer 110 may route the authorization request via a payment network 112 to the server computer 114 operated by the issuer of a payment account that is associated with the payment card/device 202. As is also well known, the payment account transaction authorization response message (also referred to as an “authorization response”) generated by the payment account issuer server computer 114 may be routed back to the POS terminal 206 via the payment network 112 and the acquirer computer 110.

The payment card issuer server computer 114 may be operated by or on behalf of a financial institution (“FI”) that issues payment accounts to individual users and other entities. For example, the payment account issuer server computer 114 may perform such functions as (a) receiving and responding to requests for authorization of payment account system transactions to be charged to payment accounts issued by the FI; and (b) tracking and storing transactions and maintaining account records.

The components of the system 200 as depicted in FIG. 2 are only those that are needed for processing a single transaction. A typical payment account system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment cards or other devices for initiating payment transactions by presenting an associated payment account number or token to the reader component of a POS terminal.

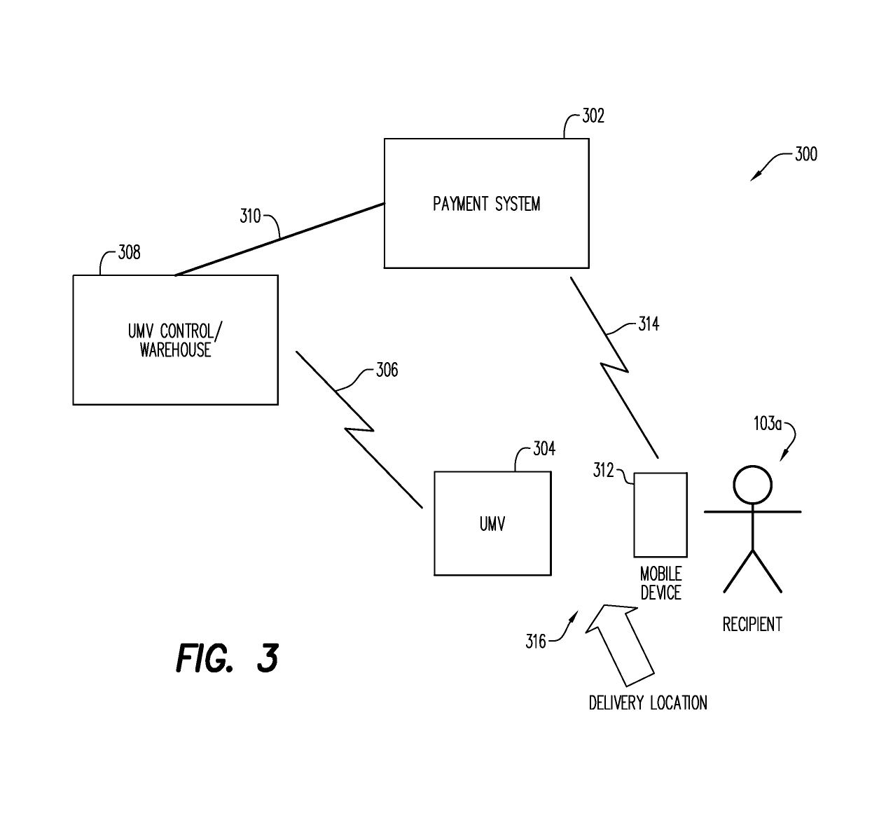

FIG. 3 is a block diagram showing a system 300 for unmanned delivery of items according to teachings of the present disclosure. It should be understood that the system 300 shown in FIG. 3 may be constituted in the context of, and in cooperation with, the types of payment systems shown in FIGS. 1 and 2. One or more of those payment systems are represented by block 302 in FIG. 3. In some embodiments, the payment system 302 may be modified so as to provide one or more services to support functionality of the system 300 as described herein.

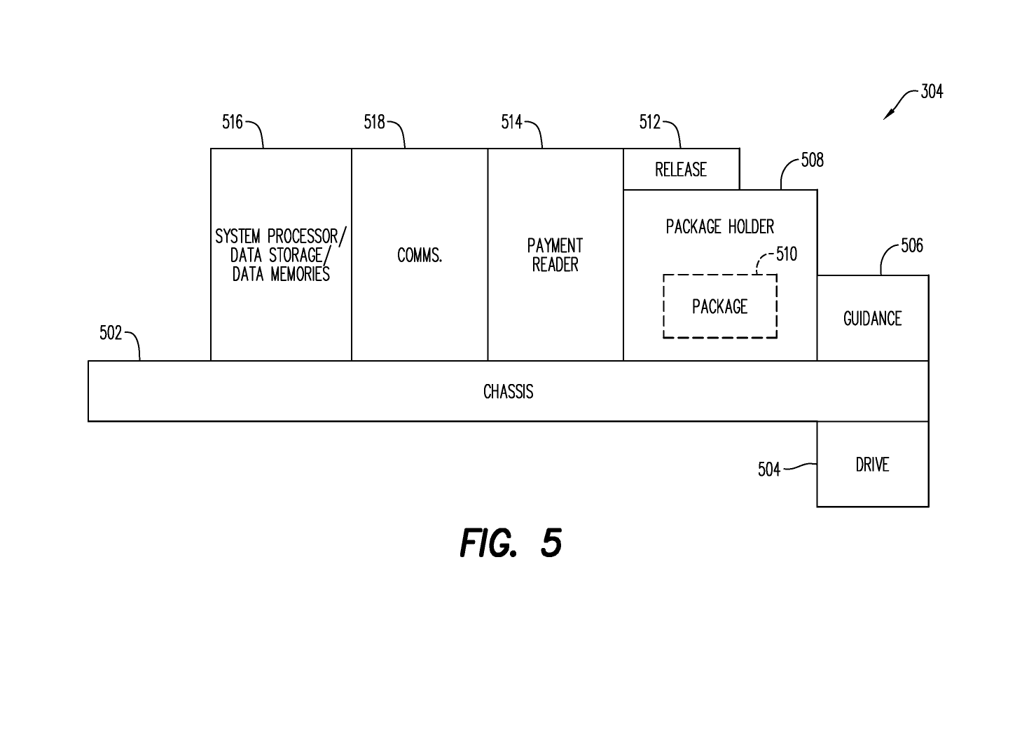

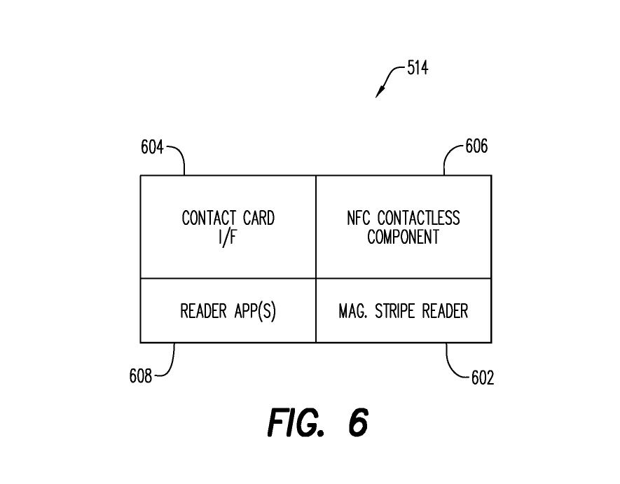

Another component of the system 300 is an unmanned vehicle (UMV) 304 provided in accordance with aspects of the present disclosure. Details of the UMV 304 will be described below, particularly but not exclusively with respect to FIGS. 5 and 6. In some embodiments, for example, the UMV 304 may be a drone or a self-driving automobile.

The UMV 304 is shown as being in at least occasional wireless data communication 306 with a UMV control/warehouse facility 308. A communication channel 310 may also exist between the UMV control/warehouse facility 308 and the payment system 302.

Also shown in FIG. 3 is a recipient 103a. The recipient 103a may be, for example, a payment system customer (e.g., as shown at 103 in FIG. 1) or an individual selected by the customer 103 or otherwise designated to receive an item ordered/purchased by an online shopping transaction or a MOTO transaction.

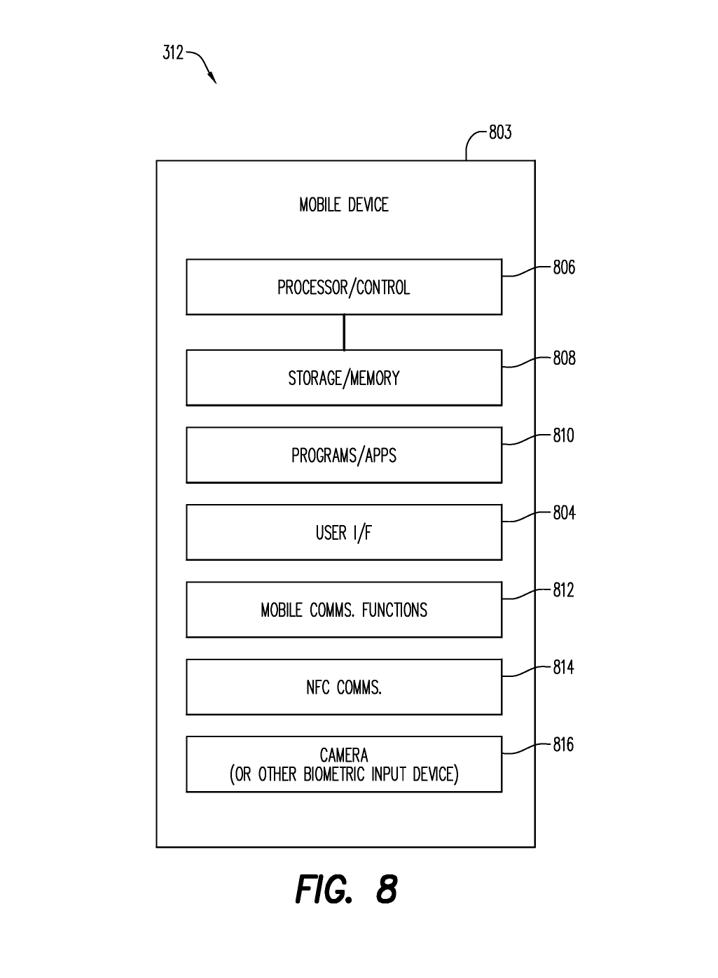

The recipient 103a carries and uses a mobile device 312. Details of the mobile device 312 are described below, particularly but not exclusively with respect to FIG. 8. The mobile device 312 may be, in some embodiments, a payment-enabled mobile device. In some embodiments, the mobile device 312 may include functionality that makes it suitable to receive biometric input from the recipient 103a. In some embodiments, the mobile device 312 may be in remote data communication (as indicated at 314), at least occasionally, with the payment system 302.

The recipient 103a, the mobile device 312 and the UMV 304 are shown as all being located at a delivery location 316. The delivery location 316 may have been designated in advance, i.e. when the item(s) to be delivered were purchased/ordered. For example, the delivery location 316 may be at or outside of the residence of the recipient 103a.

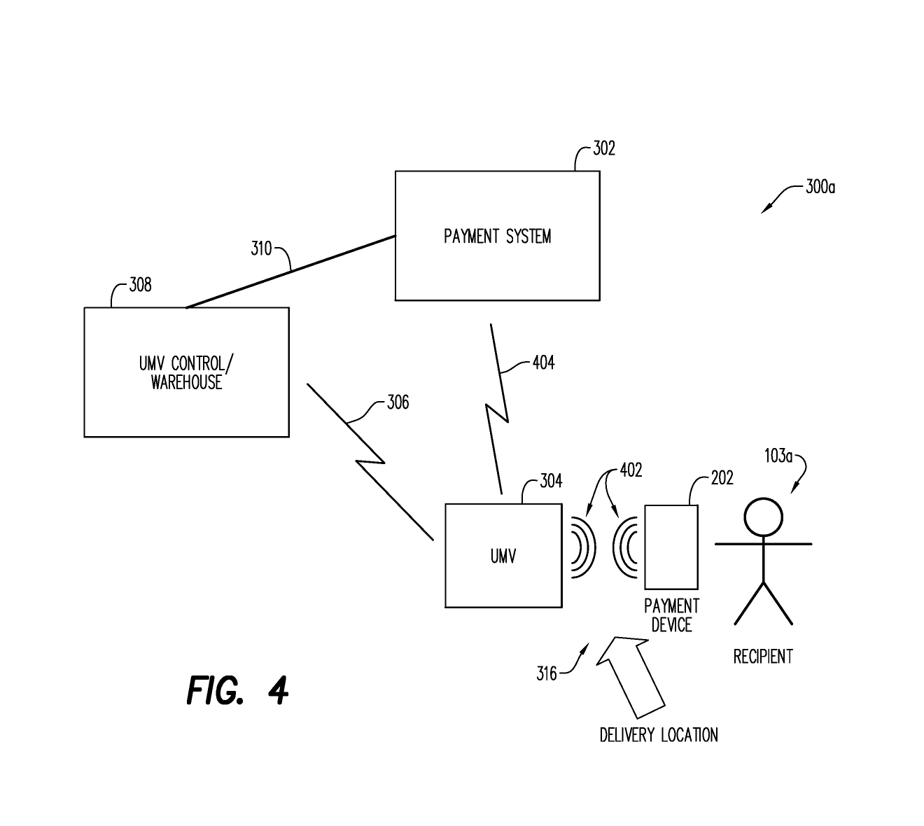

FIG. 4 is a block diagram showing an alternative embodiment (reference numeral 300a) of the system of FIG. 3.

In FIG. 4, similar or essentially the same components are shown corresponding to the payment system 302, the UMV 304, the UMV control/warehouse facility 308, and the communication channels 306 and 308. The recipient 103a and the delivery location 316 are also shown again. In the system 300a of FIG. 4, the recipient 103a carries/uses a payment device 202 such as that described above in connection with FIG. 2. Thus, the payment device 202 may be a payment-enabled mobile device or alternatively a payment card (mag stripe and/or an IC payment card). At 402, the payment device 202 is shown interacting with the UMV 304. The latter may, in this embodiment, function at least at times in a similar role to the POS terminal 206/reader 204 shown in FIG. 2. As indicated at 404, remote data communications may occur at least occasionally between the UMV 304 and the payment system 302.

With respect to both FIGS. 3 and 4, it should be understood that blocks which represent named entities therein may also be considered to represent one or more computer systems operated by or on behalf of such entities. Although only one UMV is shown in FIGS. 3 and 4, in practice fleets of UMVs may be deployed. There may also be more than one UMV control/warehouse entity, more than one payment system, and of course numerous recipients of parcels. Thus FIGS. 3 and 4 are schematic representations that show only some system components that may be required for a single item delivery to occur.

FIG. 5 is a schematic illustration of an example embodiment of the UMV 304 as shown in FIGS. 3 and 4, and as provided in accordance with aspects of the present disclosure. As noted before, the UMV 304 may be, for example, a drone or a self-driving automobile. (As used herein and in the appended claims, the term “automobile” includes motor vehicles of various body types, including sedans, station wagons, vans, pickup trucks, SUVs, panel trucks, and other sorts of trucks.)

The UMV 304 may include a chassis 502, which may be the main structural support component for the UMV 304 and its other components.

A drive component 504 of the UMV 304 is coupled to/supported on the chassis 502. In some embodiments, the drive component 504 may include a motor, transmission, steering, wheels and tires, or alternatively propellers, rotors, wings, or other mechanisms to apply motive force and direction to propel the chassis 502 (and hence the UMV 304) toward a destination (such as the delivery location 316 shown in FIG. 3 or FIG. 4).

A guidance component 506 of the UMV 304 is also coupled to/supported on the chassis 502. The guidance component 506 may include programmable electronics (not separately shown) and may control the drive component 504 to navigate the UMV 304 to selected destinations. The guidance component 506 may be self-guiding once a destination has been selected/entered into the guidance components 506 and/or may receive guidance signals by radio communications so as to be subject to remote control (e.g., by a human operator at a distant location relative to the UMV 304). The guidance component 506 may, for example, include GPS (Global Positioning System) functionality, which is not separately shown.

In some embodiments, the chassis 502, the drive component 504, and the guidance component 506 may be provided according to presently available proposals for UMVs and/or in accordance with subsequently developed designs for UMVs.

The UMV 304 may also include a package holder component 508. The package holder component 508 may be provided in accordance with teachings of the present disclosure. The package holder component 508 may be coupled to/supported on the chassis 502.

A package 510 is shown in phantom and is assumed to be contained within (and/or grasped by) the package holder component 508 of the UMV 304. In accordance with aspects of the present disclosure, the package holder component 508 includes a securing mechanism, which is not shown apart from the package holder component 508. The securing mechanism may operate to prevent the package 510 from being removed from the package holder component 508 unless or until a release mechanism 512 (associated with the package holder component 508) operates to release the securing mechanism so that a recipient (for example) is permitted to remove the package 510 from the package holder component 508.

Although only one package holder component 508 is shown in FIG. 5, nevertheless, in some embodiments, the UMV 304 may include two or more package holder components, such that the UMV 304 has capabilities of carrying more than one package at a given time, so that the UMV 304 may deliver two or more packages on a single occasion and/or may traverse a delivery route to deliver packages at two or more locations.

Also in accordance with aspects of the present disclosure, the UMV 304 may include a payment transaction reader 514. The payment transaction reader 514 may be coupled to/supported on the chassis 502.

The payment transaction reader 514 may emulate much or all of the functionality of the reader component 204 shown in FIG. 2. Some details of the payment transaction reader 514 will now be described with reference to FIG. 6.

FIG. 6 is a block diagram representation of an example embodiment of the payment transaction reader 514 shown in FIG. 5. Referring to FIG. 6, the payment transaction reader 514 may include one or more of a magnetic stripe reader 602, a contact IC card reader 604, and an NFC transceiver and/or contactless IC card reader 606. One or more application programs 608 may control the payment transaction reader 514 such that the components 602, 604 and 606 are operable to emulate the payment-device-reading functions typically provided at the point of sale in a retail store.

Referring again to FIG. 5, the UMV 304 may also include a control unit, which is indicated at 516 in FIG. 5, and which may include a system processor, associated data storage and memory components, etc. The control unit 516 may be programmed to provide overall supervision and management for the UMV 304 and/or some or all of its components. Accordingly, data/signaling channels (not shown) may be present to connect the control unit 516 with at least some other components of the UMV 304. The control unit 516 may be supported on or by the chassis 502.

Continuing to refer to FIG. 5, the UMV 304 may also include a communications module 518. The communications module 518 may facilitate data communication between the UMV 304 (or components thereof, such as the control unit 516 and the guidance component 506) with other devices/systems, such as the UMV control/warehouse 308 and/or the payment system 302 and/or the mobile device 312 shown in FIG. 3. The communications module 518 may, for example, be registered with and operable through one or more mobile communications networks to allow the UMV 304 and/or components thereof to engage in data communications with remote or other devices.

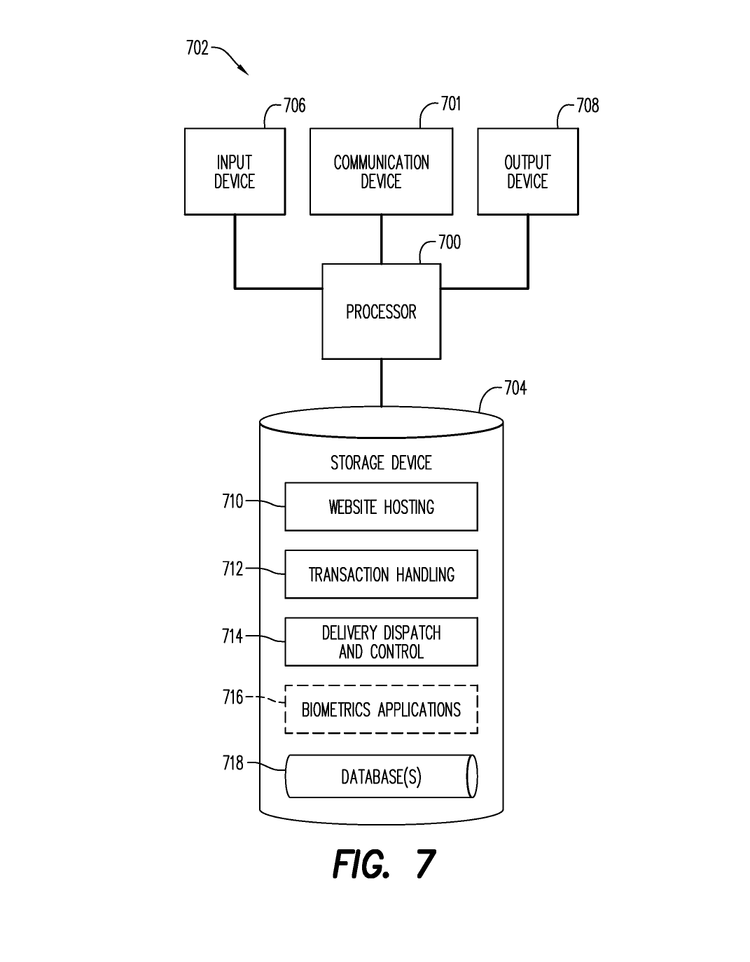

FIG. 7 is a block diagram representation of an embodiment of a computer system 702 that may provide a portion of the functionality of the systems 300 and/or 300a shown in FIGS. 3 and 4. Although the computer system 702 is on first impression indicative of a single computer, in practice it may represent two or more cooperating computers, such as a merchant's e-commerce computer server and/or a UMV control computer operated by or at the UMV control/warehouse 308. In some embodiments, the functions discussed below with respect to computer system 702 may indeed be performed by one computer or computer system.

In some embodiments, hardware aspects of the computer system 702 may be constituted by typical server computer and/or mainframe computer hardware, but may be controlled by software to cause it to function as described herein.

The computer system 702 may include a processor 700 operatively coupled to a communication device 701, a storage device 704, an input device 706 and an output device 708. The communication device 701, the storage device 704, the input device 706 and the output device 708 may all be in communication with the processor 700.

The processor 700 may be constituted by one or more processors. The processor 700 may operate to execute processor-executable steps, contained in program instructions described below, so as to control the computer system 702 to provide desired functionality.

Communication device 701 may be used to facilitate communication with, for example, other devices (such as customer devices such as the item 104 shown in FIG. 1; an acquirer computer 110, as in FIG. 1; a user authentication facility operated in conjunction with a payment network 112, numerous UMVs, etc.). For example, communication device 701 may comprise numerous communication ports (not separately shown), to allow the computer system 702 to perform its roles in connection with numerous simultaneous online purchase transactions, as well as numerous unmanned item delivery operations.

Input device 706 may comprise one or more of any type of peripheral device typically used to input data into a computer. For example, the input device 706 may include a keyboard and a mouse. Output device 708 may comprise, for example, a display and/or a printer.

Storage device 704 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 704 stores one or more programs for controlling processor 700. The programs comprise program instructions (which may be referred to as computer readable program code means) that contain processor-executable process steps of the computer system 702, executed by the processor 700 to cause the computer system 702 to function as described herein.

The programs may include one or more conventional operating systems (not shown) that control the processor 700 so as to manage and coordinate activities and sharing of resources in the computer system 702, and to serve as a host for application programs (described below) that run on the computer system 702.

The programs stored in the storage device 704 may also include website hosting software 710 that controls the processor 700 to enable the computer system 702 to host a merchant's e-commerce website. In some embodiments, the website hosting software may provide functionality commonly available with respect to hosting of online shopping websites.

Further, the storage device 704 may store a transaction handling application program 712. The transaction handling application program 712 may control the processor 700 such that the computer system 702 handles online shopping transactions as requested by customers who visit the merchant's e-commerce website. In some embodiments, the transaction handling application program 712 may provide functionality commonly available with respect to online shopping transactions. In some embodiments, the transaction handling application program 712 may also support one or more customer-selectable delivery options relating to unmanned delivery capabilities in the systems 300 and/or 300a. In some embodiments, for example, the customer may be permitted to opt for unmanned delivery and to specify a delivery location and time/date. In some embodiments, the location, time and date options made available to the customer in connection with unmanned delivery may be determined by the computer system 702 as consistent with constraints such as the previously scheduled workload for the merchant's warehouse (or warehouse contractor) and UMV fleet, as well as the geographic reach of the merchant's UMV delivery operations.

Still further, the storage device 704 may store a delivery dispatch and control application program 714 that controls the processor 700 to enable the computer system 702 to manage and control (in real time, for example) UMV delivery operations and possibly conventional shipment operations as well. At least some UMV delivery features of the delivery dispatch and control application program 714 may be provided in accordance with aspects of the present disclosure. Some details of functionality provided through the delivery dispatch and control application program 714 are described below.

In addition, and as shown in phantom in FIG. 7, the storage device 704 may store software 716 for programming the processor 700 to perform biometric enrollment and/or verification functions. As will be seen, such biometric functions may support recipient verification in connection with unmanned delivery operations according to aspects of the present disclosure. In other embodiments, the computer system 702 may rely on and interact with biometric verification functions provided by another party, such as an operator of a payment network 112 (FIGS. 1 and 2).

Continuing to refer to FIG. 7, the storage device 704 may also store, and the computer system 702 may also execute, other programs, which are not shown. For example, such programs may include a reporting application, which may respond to requests from system administrators for reports on the activities performed by the computer system 702. The other programs may also include, e.g., device drivers, database management programs, communications software, etc.

The storage device 704 may also store one or more databases (reference numeral 718) required for operation of the computer system 702.

Other computers that provide portions of the functionality of the systems 300, 300a may also have the same type of hardware architecture and/or components as described above in connection with FIG. 7, and may be suitably programmed for the respective roles of those computer components.

FIG. 8 is a block diagram that shows some features of a typical embodiment of the mobile device 312 shown in FIG. 3.

Continuing to refer to FIG. 8, the mobile device 312 may include a housing 803. In many embodiments, the front of the housing 803 is predominantly constituted by a touchscreen (not separately shown), which is a key element of the user interface 804 of the mobile device 312.

The mobile device 312 further includes a mobile processor/control circuit 806, which is contained within the housing 803. Also included in the mobile device 312 is a storage/memory device or devices (reference numeral 808). The storage/memory devices 808 are in communication with the processor/control circuit 806 and may contain program instructions to control the processor/control circuit 806 to manage and perform various functions of the mobile device 312. As is well-known, a device such as mobile device 312 may function as what is in effect a pocket-sized personal computer (assuming for example that the mobile device is a smartphone), via programming with a number of application programs, or “apps”, as well as a mobile operating system (OS). (The apps are represented at block 810 in FIG. 6, and may, along with other programs, in practice be stored in block 808, to program the processor/control circuit 806.) As is typical for mobile devices, the mobile device 312 may include mobile communications functions as represented by block 812. The mobile communications functions 812 may include voice and data communications via a mobile communication network with which the mobile device 312 is registered.

In addition, it may be assumed (though not necessarily required for purposes of the system 300) that the mobile device 312 may have hardware and software features that allow the mobile device 312 to be used as a contactless payment device. Accordingly, the mobile device 312 may include short-range radio communications capabilities (block 814), including for example NFC and/or Bluetooth.

Also, like a typical smartphone, the mobile device 312 may include a camera 816. The camera 816 may operate to capture images of the user's face for purposes of allowing the mobile device (or a remote device) to perform facial recognition processing. In addition or alternatively, the mobile device 312 may include a fingerprint sensor (also represented by block 816) or another component of the mobile device 312 by which a biometric measure may be taken from the user (i.e., the recipient 103a, FIG. 3) of the mobile device 312.

From the foregoing discussion, it will be appreciated that the blocks depicted in FIG. 8 as components of the mobile device 312 may in effect overlap with each other, and/or there may be functional connections among the blocks which are not explicitly shown in the drawing. It may also be assumed that, like a typical smartphone, the mobile device 312 may include a rechargeable battery (not shown) that is contained within the housing 803 and that provides electrical power to the active components of the mobile device 312.

It has been posited that the mobile device 312 may be embodied as a smartphone, but this assumption is not intended to be limiting, as mobile device 312 may alternatively, in at least some cases, be constituted by a tablet computer or by other types of mobile computing devices.

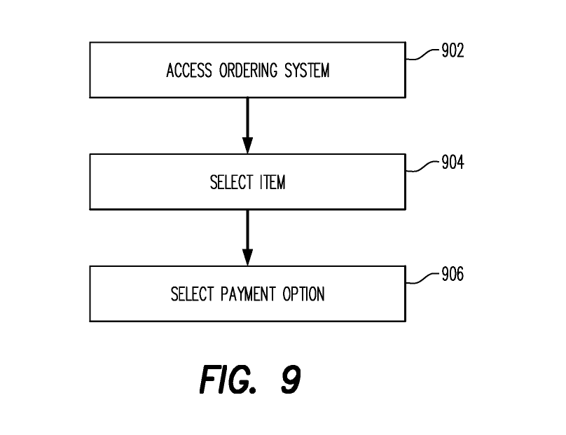

FIG. 9 is a flow chart that illustrates a process that may be performed in connection with aspects of the present disclosure in the system of FIG. 3 or FIG. 4.

At 902 in FIG. 9, a customer (and potential recipient) may access a product item ordering system such as an e-commerce website hosted by the computer system 702 (FIG. 7). Alternatively, the customer may dial in to a merchant's toll-free number to access a call center at which the customer's order may be taken (e.g., with reference to a printed catalog that was mailed to the customer). Step 902 may alternatively involve a customer's interaction with a merchant's IVR (interactive voice response) system for the purpose of product ordering. As still another alternative, the customer may mail in an order to the merchant (e.g., using an order blank from a printed catalog).

Continuing to refer to FIG. 9, at 904 (which may overlap with 902), the customer may select one or more items that the customer wishes to purchase from the merchant. In some embodiments, blocks 902 and 904 may be performed in accordance with typical practices for ordering items from a remote/online merchant.

At 906, the customer may select a manner of paying for the item purchase transaction. For example, the merchant may give the customer the option of deferring some or all of the payment for the item until the customer receives delivery of the item, where the delivery is to be accomplished by UMV. It may be another option for the customer to arrange full payment at the time of order, e.g., by a payment account transaction such as is commonly done in connection with conventional online shopping transactions. In any case, at 906 the customer may select among the payment options offered by the merchant. Even where the customer is permitted to, and elects to, defer payment (or a portion of payment) until delivery of the item, this portion of the transaction may require the customer to enter his/her payment account number (or a payment token that stands in for the account number). This portion of the transaction may also require the customer to enter his/her mobile phone number to facilitate subsequent operations (as described below) relating to delivery by UMV. It will be appreciated that—at least in the e-commerce context—the account information and/or the customer's mobile phone number may already be “on file” with the merchant's e-commerce computer.

As noted before, the product ordering process may also, in some cases, include the customer's specifying the customer's desired delivery location and time/date of delivery for delivery via UMV. This input by the customer may be within parameters set by the merchant regarding the merchant's UMV delivery capabilities and prior commitments. The product ordering process may also involve the customer indicating whether the recipient of the delivery is to be the customer himself/herself or another individual. If the latter, the customer may be required to input information about the recipient, including the recipient's mobile phone number.

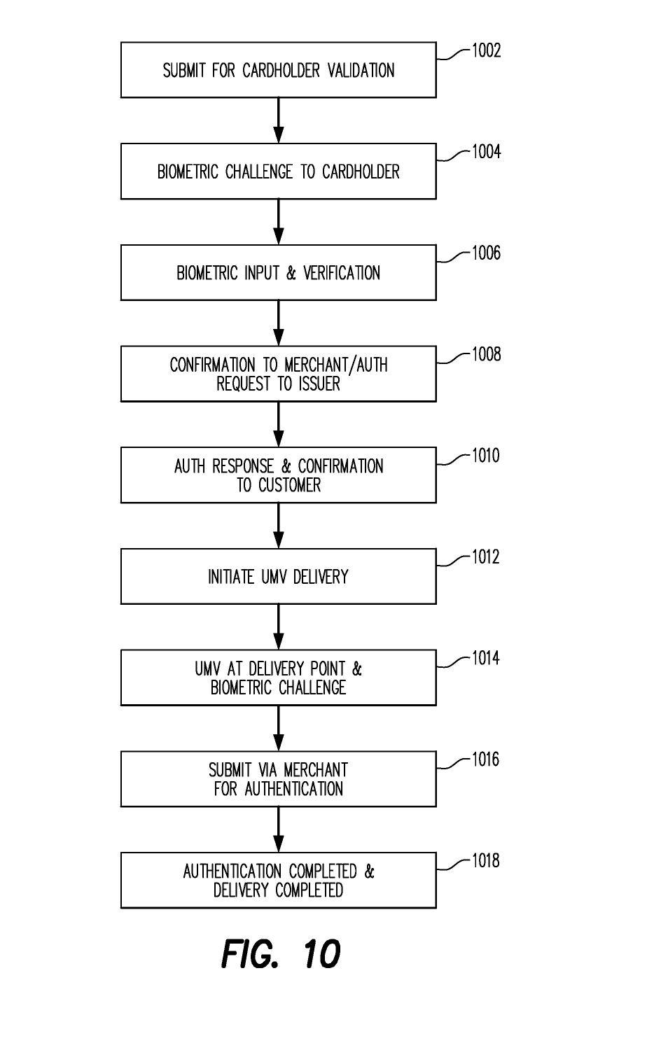

FIG. 10 is a flow chart that illustrates another process that may be performed in connection with aspects of the present disclosure in the system of FIG. 3 or FIG. 4.

At 1002 in FIG. 10, the merchant (e.g., via the computer system 702) may submit the customer's payment account information for validation of the customer/account information. In some embodiments, this submission may be made to a component of the payment system 302, such as a cardholder validation service provided by the operator of a payment network.

At 1004, the cardholder validation service may identify the cardholder/account holder and may issue a biometric challenge to the cardholder/account holder (who is the customer referred to above in connection with FIG. 9 and block 1002 in FIG. 10). The biometric challenge may be presented to the cardholder/account holder via his/her mobile device (i.e., in response to communication from the cardholder validation service to a suitable app in the customer's mobile device). The mobile device may prompt the customer to make a biometric input (e.g., take a “selfie” for facial recognition processing, speak a word or phrase into the mobile device's microphone for voice recognition processing, or present his/her finger tip to a fingerprint sensor component of the mobile device).

Block 1006 in FIG. 10 represents the customer making the biometric input in response to the prompt from the mobile device. Block 1006 also represents verification of the biometric input. The latter may occur, for example, “in app” at the mobile device itself (assuming a suitable secure app has been installed in the mobile device) or remotely at and by the cardholder validation service. In either case, it may be assumed that the customer had previously submitted reference biometric input which was stored and against which the current biometric input may be compared.

Assuming that the cardholder validation was successfully performed, the cardholder validation service may so advise the merchant, as indicated at block 1008 of FIG. 10. Moreover, block 1008 also represents the merchant submitting an authorization request to the account issuer, via the merchant's acquirer and the payment network. For example, this authorization request may be to cover a partial payment for the transaction as may have been required of the customer in the process of FIG. 9.

Again it is assumed that no adverse development occurs, and that the account issuer approves the transaction and generates an authorization response to that effect, as indicated at block 1010 in FIG. 10. Block 1010 may also be taken to indicate that the merchant informs the customer that the transaction is confirmed.

At block 1012 in FIG. 10, the merchant may initiate UMV delivery of the purchased item. This may entail launching suitable activities at the UMV control/warehouse 308 (FIG. 3 or FIG. 4). These activities may include expedited picking of the purchased item from the warehouse for same-day delivery, securing the item/package to an available UMV (e.g., in the package holder 508 as described in connection with FIG. 5) and dispatching the UMV with the item so that the UMV will navigate to the established delivery location. The dispatching of the UMV may include communicating/inputting the street address of the delivery location to the UMV. The UMV may then proceed with standard GPS, navigation and mapping functions to travel to the delivery location. At least in the case of a UMV that is a drone, the traveling of the UMV may involve customary obstacle/collision evasion/avoidance. It may be the case that the UMV control/warehouse 308 tracks the progress of the UMV (e.g., based on location updates sent from the UMV to the UMV control/warehouse 308). In connection with tracking the UMV's progress, the UMV control/warehouse or the merchant (which may be one and the same) may send one or more text updates to the mobile device 312 (FIG. 3) belonging to the recipient 103a to confirm to the recipient an estimated time of arrival by the UMV at the delivery location.

Block 1014 represents arrival of the UMV 304 at the delivery location 316 with the package/item to be delivered to the recipient 103a. In addition, block 1014 may be taken to represent a second stage of validation in which a biometric challenge is sent to the recipient via the mobile device 312. The recipient's submission of biometric input in response to the challenge may be considered the recipient's signing of an electronic delivery receipt as well as compliance with a request for verification of the recipient's identity.

At block 1016, the merchant may submit the biometric input to the payment system along with an authorization request for a payment transaction to pay the balance due on the transaction. The biometric input may have been relayed from the mobile device 312 to the UMV 304 and then on from the UMV 304 to the UMV control/warehouse 308, which is or represents the merchant. A user validation service that is part of the payment system 302 may be requested to verify the biometric input.

At block 1018, the authentication of the recipient is completed and an authorization response may be received by the merchant from the account issuer indicating approval of the payment account transaction for payment of the balance due on the item to be delivered. The UMV control/warehouse 308 may then signal to the UMV 304 to release the purchased item (i.e., to actuate the release mechanism 512 (FIG. 5) so that the recipient 103a (FIG. 3 or FIG. 4) may remove the purchased item from the package holder 508 (FIG. 5) of the UMV 304. The transaction and delivery are now complete, including biometric verification of the recipient, which also serves as the recipient's acknowledgement of the delivery.

There may be alternative signal flows instead of the signal flow described above. For example, the UMV 304 may signal to the UMV control/warehouse 308 that it has arrived at the delivery location. The merchant may then submit an authorization request via the payment system 302. A user validation service provided by the payment system 302 (e.g., from the operator of the payment network) may issue the biometric challenge to the mobile device 312. The user's response to the challenge—i.e., the recipient's biometric input—may be sent back to the user validation service. The user validation service may verify the biometric input against reference biometric data previously submitted to the user validation service by the recipient. The payment network may then route the authorization request to the account issuer, with an indication that the account holder/recipient has been authenticated. The account issuer may generate an authorization response approving the payment account transaction. The authorization request may be routed via the payment network and the acquirer to the merchant, with an indication that the recipient has been authenticated. The merchant may then cause the UMV 304 to be signaled to release the purchased item to the recipient 103a.

In some embodiments and/or in some situations, full payment may be made (via a payment account transaction, e.g.) at the time of ordering. Accordingly, release of the purchased item at the delivery location may not require a further transaction authorization request and approval; rather, in some embodiments, only biometric authentication of the recipient (or another type of user authentication, as described below) may be required.

According to another alternative signal flow, the UMV 304 may serve as a payment device reader at the delivery location. The recipient 103a may submit his/her payment card/device to be read (e.g., via magnetic stripe swipe, contactless reading of a contactless payment IC card or payment-enabled mobile device, or reading via direct contact of a contact-type payment IC card) by the payment transaction reader 514 (FIG. 5) of the UMV 304. The recipient's presentation of a valid payment card/device to the UMV 304 may be deemed sufficient to authenticate the recipient. The validity of the payment card/device may be confirmed by messaging from the UMV to the merchant (via the communications module of the UMV) to the account issuer via the payment system. In some embodiments, no biometric authentication of the recipient may be required in view of the recipient's presentation of the payment card/device to the UMV 304. In other embodiments, the payment card/device may be a payment-enabled mobile device in which the user's access to a payment application on the mobile device is dependent on a successful biometric verification, such as a successful scan of the user's fingerprint. So in the latter case, there is biometric authentication of the recipient along with reading of the payment device by the UMV 304.

It is further within the contemplation of this disclosure that the UMV may be equipped with a currency acceptance device (not shown). In such embodiments, the recipient may make a cash payment into the currency acceptance component of the UMV to obtain release of the purchased item from the UMV.

In other embodiments, the UMV may be equipped with one or more suitable components (not shown) for receiving biometric input directly from the recipient, rather than through the recipient's mobile device. For example, the UMV may include a camera for capturing an image of the recipient's face (for facial recognition), a microphone for receiving a spoken utterance by the recipient (for voice recognition) and/or a fingerprint sensor.

In some embodiments, the customer/recipient may register biometric reference data with the merchant (or the merchant's delivery contractor) in a set-up operation prior to making purchases from the merchant. The merchant or delivery contractor may, in such embodiments, perform the biometric authentication of the recipient upon delivery instead of relying on a user validation service or the like provided by the payment system 302.

In some embodiments of the systems 300, 300a, the UMV 304 may not be equipped with payment transaction reader functionality, and other signaling flows, as described above, may assure verification of the recipient by validation of biometric input provided by the recipient.

In some embodiments, in lieu of biometric authentication of the recipient, the recipient may be authenticated via a one-time password (OTP). The OTP may have been supplied to the recipient by the merchant prior to or at the time of delivery by transmission from the merchant to the recipient's mobile device. The recipient may then enter the OTP at the delivery location into a keypad element (not shown) included in the UMV 304. The keypad element may be virtual or hardware-based.

In some embodiments, instead of biometric authentication or OTP, the recipient may have been supplied by the merchant with a QR code or other type of barcode to be displayed by the recipient's mobile device and scanned at the delivery location via a scanning element/camera (not shown) on the UMV. Thus in this case the recipient may be authenticated by possessing and submitting the QR code via his/her mobile device for scanning by the UMV.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
transporting an item for delivery to a delivery location by an unmanned vehicle;
receiving a signal that authenticates a recipient present at the delivery location; and
releasing the item from the unmanned vehicle to the recipient in response to the received signal.

2. The method of claim 1, wherein the unmanned vehicle is a drone.

3. The method of claim 1, wherein the unmanned vehicle is a self-driving automobile.

4. The method of claim 1, wherein the received signal is indicative of a successful biometric authentication process with respect to the recipient.

5. The method of claim 1, wherein the signal is received via a payment account system.

6. The method of claim 1, wherein the signal is read by the unmanned vehicle from a payment card proffered by the recipient.

7. The method of claim 1, wherein the signal is received by the unmanned vehicle scanning a barcode displayed on a mobile device carried by the recipient.

8. The method of claim 1, wherein the recipient inputs the signal as a one-time-password (OTP) via a keypad that is part of the unmanned vehicle.

9. The method of claim 1, wherein the received signal confirms that payment has been made for the item.

10. A method comprising:
receiving an order for an item via an online shopping transaction, a telephone conversation or by mail;
receiving at least partial payment for the order via a payment account system;
transporting the ordered item for delivery to a delivery location by an unmanned vehicle;
issuing a biometric challenge to a recipient present at the delivery location;
receiving a biometric input from the recipient;
receiving, by the unmanned vehicle, an indication that biometric authentication of the recipient was successfully completed; and
in response to the received indication, releasing the transported item from the unmanned vehicle to the recipient.

11. The method of claim 10, wherein the unmanned vehicle is a drone.

12. The method of claim 10, wherein the unmanned vehicle is a self-driving automobile.

13. The method of claim 10, wherein the biometric input is an image of the recipient's face.

14. The method of claim 10, wherein the biometric input is a scan of the recipient's fingerprint.

15. The method of claim 10, wherein the biometric input is a spoken utterance by the recipient.

16. The method of claim 10, wherein said receiving at least partial payment step does not include receiving full payment for the order;
the method further comprising:
while the unmanned vehicle is present at the delivery location, processing a payment account transaction to complete payment for the order.

17. The method of claim 10, further comprising:
receiving a cash payment at the delivery location, via a cash acceptance device that is part of the unmanned vehicle.

18. An unmanned vehicle, comprising:
a chassis;
a drive mechanism attached to the chassis for propelling the chassis to selected locations;
a guidance system supported on the chassis for controlling the drive mechanism;
a package holder supported by the chassis for releasably holding an item to be delivered;
a payment device reader supported by the chassis; and
a data communication module supported on the chassis for wirelessly transmitting payment account data read by the payment device reader.

19. The unmanned vehicle of claim 18, wherein the payment device reader includes at least one of: (a) a magnetic stripe card reader; (b) a contact IC (integrated circuit) card reader; and (c) a short-range radio communications transceiver.

20. The unmanned vehicle of claim 19, wherein:
the payment device reader includes said short-range radio communications transceiver; and
said short-range radio communications transceiver is operable in accordance with a standard protocol for contactless payment account transactions.
